(19) United States
(12) Patent Application Publication
(10) Pub. No.: US 2014/0056571 A1
(43) Pub. Date: Feb. 27, 2014

(54) Entertainment and Educational Optical Reader System

(71) Applicants: Ebru Keni, Istanbul (TR); Hakan Keni, Istanbul (TR)

(72) Inventors: Ebru Keni, Istanbul (TR); Hakan Keni, Istanbul (TR)

(73) Assignee: AE Yayincilik, Film Ltd., Istanbul (TR)

(21) Appl. No.: 13/770,215

(22) Filed: Feb. 19, 2013

Related U.S. Application Data
(60) Provisional application No. 61/600,401, filed on Feb. 17, 2012.
(60) Provisional application No. 61/612,020, filed on Mar. 16, 2012.
(60) Provisional application No. 61/662,123, filed on Jun. 20, 2012.
(60) Provisional application No. 61/691,020, filed on Aug. 20, 2012.

(51) Int. Cl. H04N 5/765; G06K 7/10

(52) U.S. Cl. CPC H04N 5/765; G06K 7/10
USPC 386/230

(57) ABSTRACT

A system for selectively providing a set of audio and video content associated with a corresponding set of written content separately provided, the system. The system comprises a handheld reader including an optical scan reader; and a playback device, coupled to the reader through a communications link, comprising memory for storing the set of audio and video content associated with corresponding set of written content. The hand held reader is configured to (a) receive data from the optical scan reader when the optical scan reader scans steganographic coded printed material relating to and in the vicinity of associated written content and (b) transmit the data over the wireless communication link to the playback device. The playback device is configured to (1) process the data received from the reader over the wireless communications link, (2) retrieve audio and video data associated with the data received from the reader, and (3) display the video data and play the audio data on the playback device.

### CROSS-REFERENCE TO RELATED APPLICATIONS

This application claims the benefit of U.S. Provisional Application No. 61/600,401, filed on Feb. 17, 2012, U.S. Provisional Application No. 61/612,020, filed on Mar. 16, 2012, U.S. Provisional Application No. 61/662,123, filed on Jun. 20, 2012 and U.S. Provisional Application No. 61/691,020, filed on Aug. 20, 2012, the entire teachings of these applications are incorporated herein by reference.

### BACKGROUND

In today's world, education and entertainment merge, thus offering new and exciting ways to learn and use information.

### SUMMARY

A system for selectively providing a set of audio and video content associated with a corresponding set of written content separately provided, the system. The system comprises a handheld reader including an optical scan reader; and a playback device, coupled to the reader through a communications link, comprising memory for storing the set of audio and video content associated with corresponding set of written content. The hand held reader is configured to (a) receive data from the optical scan reader when the optical scan reader scans steganographic coded printed material relating to and in the vicinity of associated written content and (b) transmit the data over the wireless communication link to the playback device. The playback device is configured to (1) process the data received from the reader over the wireless communications link, (2) retrieve audio and video data associated with the data received from the reader, and (3) display the video data and play the audio data on the playback device.

### GENERAL DESCRIPTION OF THE DRAWINGS

The drawing figures depict one or more implementations in accord with the present teachings, by way of example only, not by way of limitation.

FIG. 1 is an illustration of a perspective view of an embodiment of the disclosed system;

FIGS. 2-5 illustrate various views of the FIG. 1 embodiment;

FIG. 6 is an illustration of a perspective view of a second embodiment of the disclosed system employing commercially available computerized devices such as smart phones and tablet devices;

FIG. 7A-7H are illustrations in multiple views of a third embodiment of the disclosed system;

FIG. 8 is a perspective view of the FIG. 7 embodiment with a supplemental playback device;

FIG. 9A-9D are exemplary images displayed on the playback device;

FIG. 10 is a high-level block diagram of one embodiment of data processing architecture of the disclosed system;

FIG. 11 is a high level block diagram of one embodiment of the overall hardware architecture of a reader;

FIG. 12 is a block diagram of one embodiment of the overall architecture of a playback device; and.

FIG. 13 is a flow chart diagram of one embodiment of the operation of a device of the type described herein.

FIG. 14 is an illustration of different perspective views of an embodiment of the disclosed system employing commercially available computerized devices such as smart phones;

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details.

A portable, handheld electronic system that interacts with printed materials, such as books, and offers both video and audio supplemental content capabilities is described. The system includes a reader and a playback device. The playback device and the reader may be included in one physical unit or function as two independent units that are coupled via a physical, network, or wireless connection. In some embodiments, the system includes an optical reader, positioned, for example, at one end of a stylus, and a playback device that offers audio and video content capabilities. The stylus interacts with especially coded printed material and sends information regarding same to the playback device. The reader can also take other forms, such as a plug-in device configured to plug into a data port of commercially available computerized devices such as smart phones and tablets, or within a housing integrated with the playback device. The coded printed material is preferably steganographic and can be in the form of a watermark that contains data that can be processed by the optical reader. In response to sensing this steganographic data, the playback device generates audio or video content specifically associated with and relating to the steganographic data acquired from the watermark. In some embodiments, the printed material may be especially encoded printed material that is visible to the reader, but not the naked eye.

In some embodiments, the playback device includes a video display. The video display may include a touch screen. In some embodiments, the video display may be a display screen coupled with or included in a computing device such as a desktop computer, tablet computer, Personal Digital Assistant (PDA), smart phone, mobile device, etc. In some embodiments, the playback device may be configured to play at least one of video, audio, still images, text, games, or similar content.

The term “optical reader,” as used herein, may refer to any type of reader or scanner known in the art that can be used to obtain the steganographic data when the watermark is imaged and/or scanned. The optical reader may include an optical reader adapted to image and/or scan printed material in the visible spectrum, but also in other parts of the spectrum including or limited to, for example, the near infrared.

In some embodiments the playback device may be provided as a handheld display accessory. The handheld display accessory may be rectangular or in another shape, such as a commercially available smart phone or tablet device. The handheld display accessory may also be in a shape that is contoured to a user's hand, and configured to include a display screen, and provide an audio output.

Alternatively, the handheld display accessory may also be configured to connect to a device including the display screen and audio output. For example, the handheld display accessory may include a connection port (e.g., a USB plug) that is configured to plug into a connection slot (e.g., a USB slot) on the display. In other embodiments, the handheld display accessory may be configured to be stowed into a compartment in the display.

In certain embodiments the playback device includes memory for storing video and audio content. The video and audio content may be selected files each corresponding to the data contained in the steganographic image provided in associated printed material, such as a book. The playback device also includes a processor configured to process data provided by the optical reader in response to imaging and/or scanning the steganographic data from the printed material, and generate the corresponding video and/or audio content.

When used in conjunction with paper (or any other medium in which content may be included or upon which the information can be applied) that is encoded with steganographic information of the type that can be imaged and/or scanned with the optical reader, the playback device will play the relevant video and/or audio content. The stenographic watermark may utilize any type of encoding data. The display may be used to enhance existing printed content, making it more interesting and satisfying to a user. In this regard, printed text can be provided, along with an encoded pattern, such as a steganographic watermark by printing the pattern over or in the vicinity of the printed text. The advantage of providing the stenographic content in a part of the spectrum that is not visible to the naked eye, such as the near infrared, is that the encoded pattern forming the steganographic information will be invisible to the naked eye, and thus clearly distinguishable from other printed material, such as text, that is visible to the naked eye. Thus, the watermark will not provide a distraction to the person reading the text. This is particularly advantageous, for example, where the optical reader is being used to supplement visible text that tells a story, so that audio and video content associated with the specific visible printed content can be played back on the playback device so as to supplement the reading material. The encoded pattern can provide unique identifying information that associates it with particular audio and/or video content stored in the playback device.

Certain embodiments of the present invention provide the capability to listen to printed content and expand on the content of the printed content with a unique, video and/or audio playback capability. The printed content may be coded and thus used as a virtual anchor point to launch video and/or audio content.

The disclosed optical reader scans and/or images, and reads on the spot (meaning that it reads the hidden watermark on a page), retrieves the information that has been linked to the scanned and received data. Further, the optical reader does not require any additional application to be downloaded in order to acquire and process the scanned and/or imaged data prior to operating the device. In some embodiments, the supplemental content data in the form of video and/or audio files may be downloaded as library additions. For example, when the user points the reader at the word or image of a “dog” containing steganographic information associated with video and/or audio files stored on the playback device, she/he can use the display to, for example, hear the word read aloud, watch a movie of a dog, solve a puzzle with the picture of a dog on it, solve a quiz that tests her/his knowledge of dogs, and receive immediate feedback.

Using the embodiments disclosed herein, one may turn on the display, activate the reader, and proceed to hover the optical reader over a desired area of the printed content, and the display will play the video, audio, run games etc with no further action needed. Once the reader is activated, the user has the freedom to use the display to switch from among many functions, such as, for example, video and/or audio play; gaming throughout all the pages of a coded book, etc.

In certain embodiments, the optical reader may obtain information regarding the printed content without any need for coming in physical contact with the medium including the printed content (including the steganographic watermarks). Upon acquiring the steganographic data, the reader transmits the obtained data to the playback device. The reader may transmit the acquired data to the display accessory via a physical connection (e.g., coaxial cable or connection port), a network connection, or a wireless connection. The wireless technologies for the wireless technology may include, for example, Bluetooth, Wi-Fi, cellular networks (e.g., 3G or LTE technology), satellite communications, infrared, or any other wireless communication technologies.

Once the optical reader is in close vicinity of the printed material, it acquires data from the steganographic image and transmits the data to the playback device where the content matching the printed content is activated on the playback device so as play video on the screen and/or provide audio playback on suitable speakers of the playback device. From there on, the user can interact directly with the device by touching the screen or any other means known in the art.

The system need not require any connection to a cloud service or to a website. The system need not necessarily require the download of a special reader application for processing the data or playing back the video and audio content. The system need not necessarily require sharing or transferring the user information or the printed information to a server on the Internet.

The playback device may store all of the necessary programs and content, but also be coupled with a wireless modem to another source of programs and content. For example, the display and/or the reader may also include a USB port for connection to computers, so if the need arises, the content in the memory card can be updated.

In some embodiments, the display screen may be 1.8 inch, color, thin film transistor (TFT) screen, although other types and sizes of screens can be used.

In certain embodiments, the system may also have components (e.g., a camera, a microphone, etc.) with audio and/or video recording capabilities. A module that provides the system with audio and/or video recording capabilities may be included in the playback device or be an independent unit that is physically or wirelessly coupled with the playback device, such as a plug in device to a standard data port on a commercially available computerized device such as a smart phone or a tablet. In one embodiment, a user may be able to use the playback device to record his/her pronunciation of words. In some embodiments, the device may have components (e.g., speakers) that are capable of playing back recorded audio content material. For example, in some embodiments, the user's recorded sound may be played back such that the user can assess his/her recorded pronunciation of a word. In some embodiments, the system may provide feedback regarding the recording. In certain embodiments, headphones and/or microphones may be used in conjunction with the display.

In some embodiments, the display and/or reader may be powered by Lithium batteries, although other types of power supplies can be used. In some embodiments, the battery may be recharged using a USB port.

In some embodiments, the display may include an MP3 player, or any other audio player known in the art. In some embodiments, the audio player may be an independent unit that is physically or wirelessly coupled with the playback device.

Certain embodiments may include a display with TV output capabilities. In some embodiments, TV output capabilities may be obtained via wireless modem and selected as an option from the “setting” menu of the display or an application program interface (API) supported by the display device.

Some embodiments may include expandable content with memory cards. In some embodiments, a slot may be included in the playback device for inserting pre-loaded content stored on cards into the device. In some embodiments, the playback device may include a USB port that may be used to establish with a unit that can be used to read pre-loaded content stored on the cards.

Certain embodiments may include video playing capabilities.

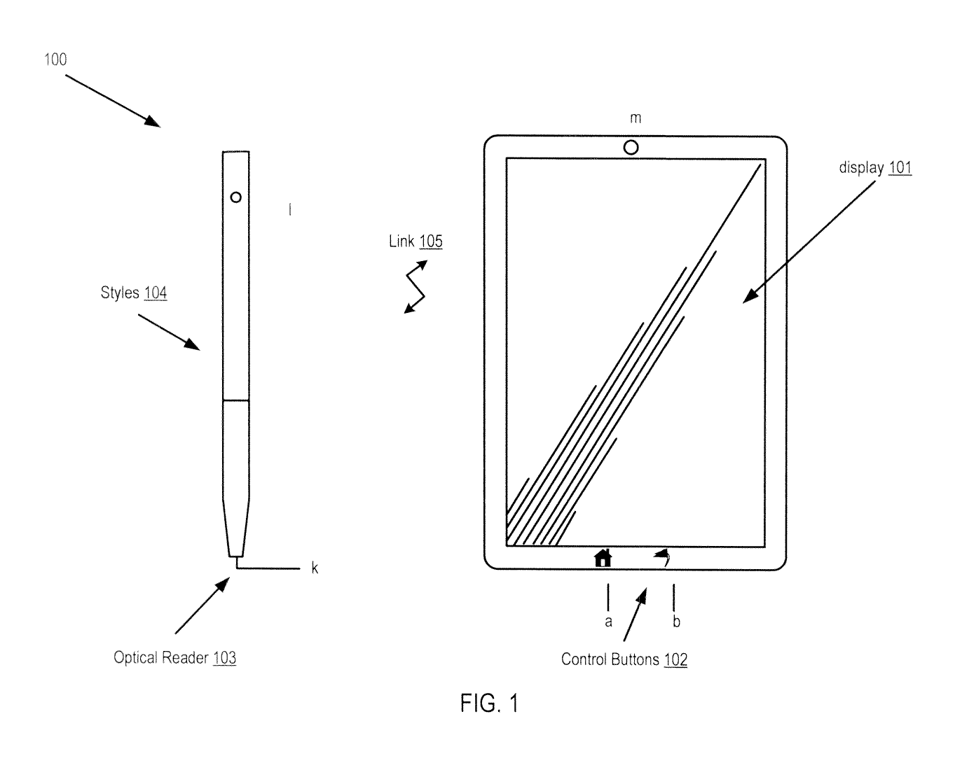

Referring to the drawings, FIG. 1 is an illustration of a perspective view of a one embodiment of a portable hand held electronic system 100. The system 100 may include a playback device 101 including a display, a separate reader device in the form of a stylus 104 including an optical reader 103, and one or more control buttons 102 provided on the playback device. In some embodiments, the playback device may include a display screen coupled with or included in a computer processing device, such as a desktop computer, tablet computer, Personal Digital Assistant (PDA), smart phone, cellular phone, mobile device, etc. In certain embodiments, an application programming interface (API) may provide the interface to application programs that determine how the information received from the optical reader is processed.

The screen of the playback device 101 may be any electronic visual display known in the art, including touch screens that can detect the presence and location of a touch within the display area. Although the term “touch” screen is used herein, one of ordinary skill in the art appreciates that in place of or in addition to use of finger or hands for “touching” the screen, other objects, such as a stylus, may be sensed by the playback device 101. The display of the playback device 101 may be used to display various media, such as images, videos, and/or computer application interfaces.

The reader 104 is shown in the form of a stylus that includes an optical reader 103 having an input at one end.

The optical reader 103 acquires information from the steganographic image that is related to and associated with the visible printed content (not shown) without any need for coming in physical contact with the medium upon with the image and content is printed. The optical reader 103 recognizes the hidden (not discernible to the naked eye) codes representing the steganographic content on a page, processes that data and responsively retrieves/plays content (video, audio, still images, etc.) associated with the hidden codes. For example, the word “dog” may appear on a printed page. A hidden steganographic code is also printed over, around, and/or near the word dog. The hidden code may be in various forms. In some embodiments, the hidden code may be in the form of any optical code known in the art such as Optical Identification (OID), or DPI (dots per inches).

The optical reader 103, when moved to scan and/or image the image of the dog, reads the hidden code and transmits data representing the hidden code to a computing unit (not shown) coupled to or within the playback device 101 over the link 105. The link may be a physical link, a network connection, or a wireless connection. Any communications link known in the art may be used to transmit the information from the reader 104 to the playback device 101.

In some embodiments the reader 104 may include a data repository (e.g., a memory module) that is configured to store content. For example, after the optical reader 103 reads the hidden code, the hidden code or some information regarding the hidden code may be stored on the data repository until it can be transmitted to the computing unit of the playback device.

In response to the code that is read by the reader 104, an appropriate file is opened by a processor (not shown) that is coupled with the playback device 101, where it is used to run the appropriate video and/or audio content. The processor may be included in the same unit as the display or be coupled with the display via a physical, network, or wireless connection. The opened file may be a video or audio file, a picture of a dog, or any other type of information for displaying/playing on the display of playback device 101.

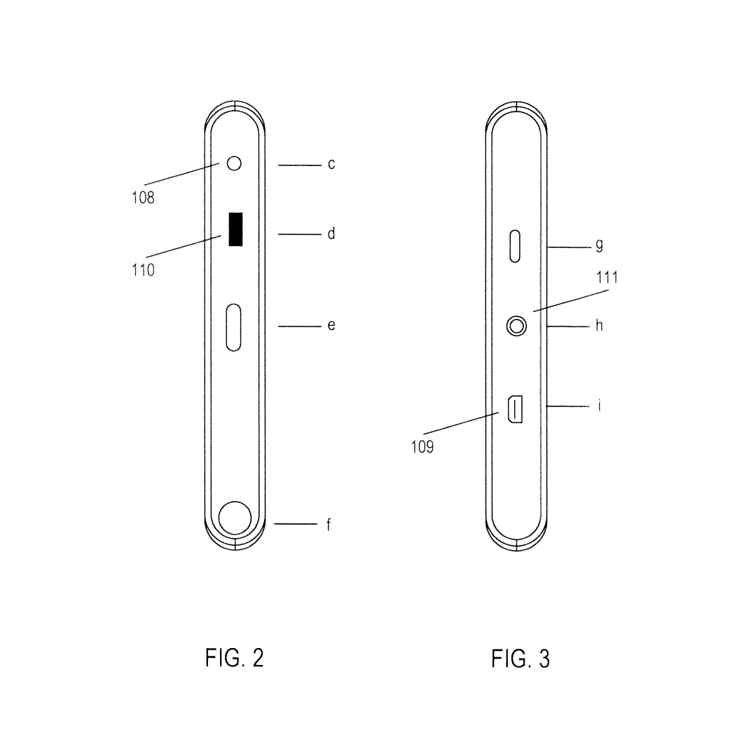

Once information regarding the printed content is obtained, the content matching the printed content is activated in a memory portion (described later with reference to FIG. 2) of the system 100. The memory may be included in the same unit as the display or be coupled with the display via a physical, network, or wireless connection.

A user (not shown) may then directly interact with the system 100 through the screen of the playback device 101 (when the screen is a touch screen) and select from among various media such as text, still image, movie, games, or computer applications.

In some embodiments, the user may use one or more control buttons 102, in place of or in addition to using the screen 101, to interact with the system 100. Although two control buttons are shown in FIG. 1, any number of control buttons may be used.

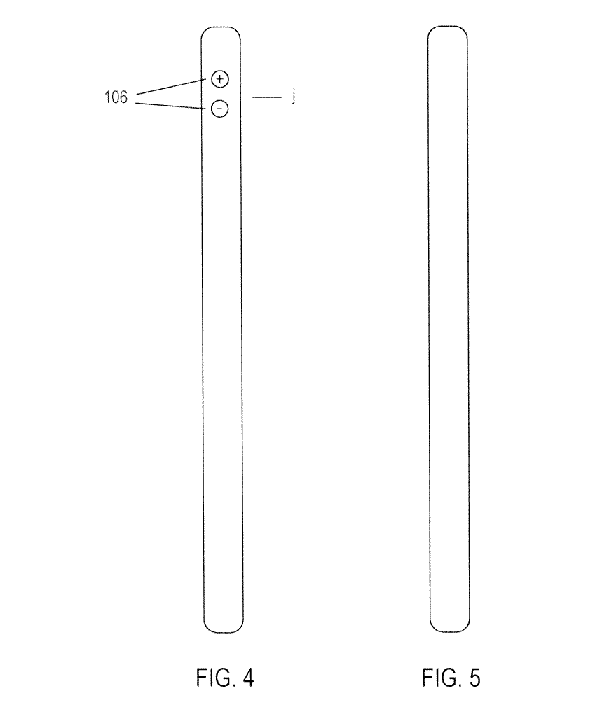

In certain embodiments, the control buttons may include buttons for controlling volume (such as shown at 106 in FIG. 4), and not shown, buttons for moving forward and back in movies, games, or applications, buttons for selecting from among available interaction options (e.g., text, still image, movie, games, or computer applications) and toggling between selections, buttons for turning the device on and/or off, buttons for controlling screen light (back light), etc. The buttons may be physical buttons or touch screen buttons.

The system 100 may further include a port 109 (see for example, FIG. 3) for connecting to various enabled devices (e.g., desktop computer). As shown the port is a USB port. The USB port 109 may be coupled to at least one of the playback device 101 as seen in FIG. 1 or to the reader 104. In some embodiments, the USB port 109 may be used to connect the system 100 to a computer to charge the battery. Alternatively, the system may connect to a plug socket with a simple adapter. The USB port 109 may be used to transfer data for additional or replacement content and other updates.

In certain embodiments, the device may also include one or more speakers (such as shown, for example, at 110 in FIG. 2). Further, in some embodiments, the system 100 may include an interface for a microphone, such as shown, for example, at 111 in FIG. 3.

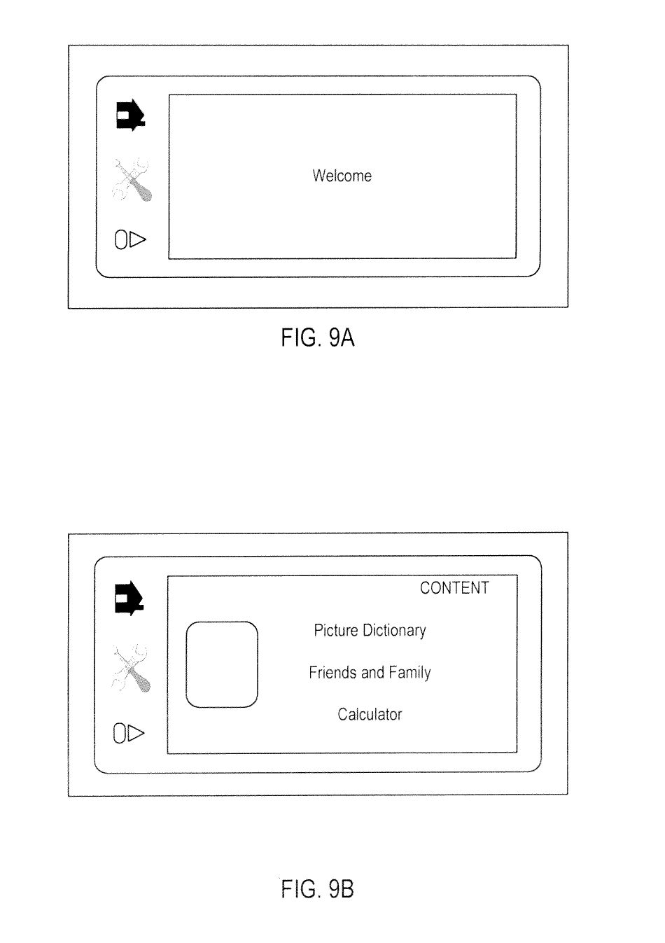

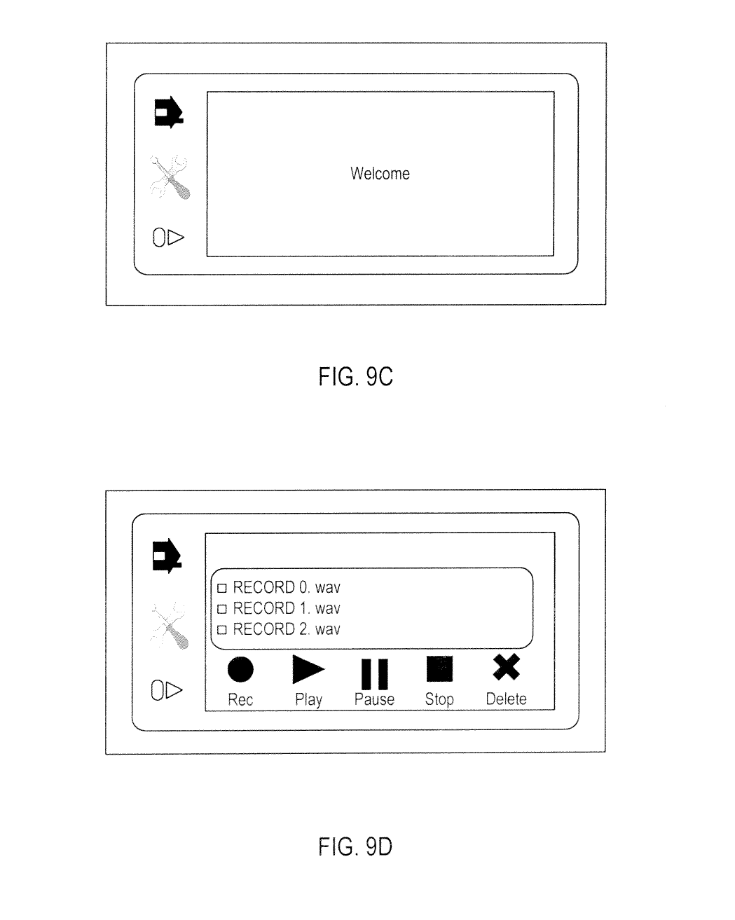

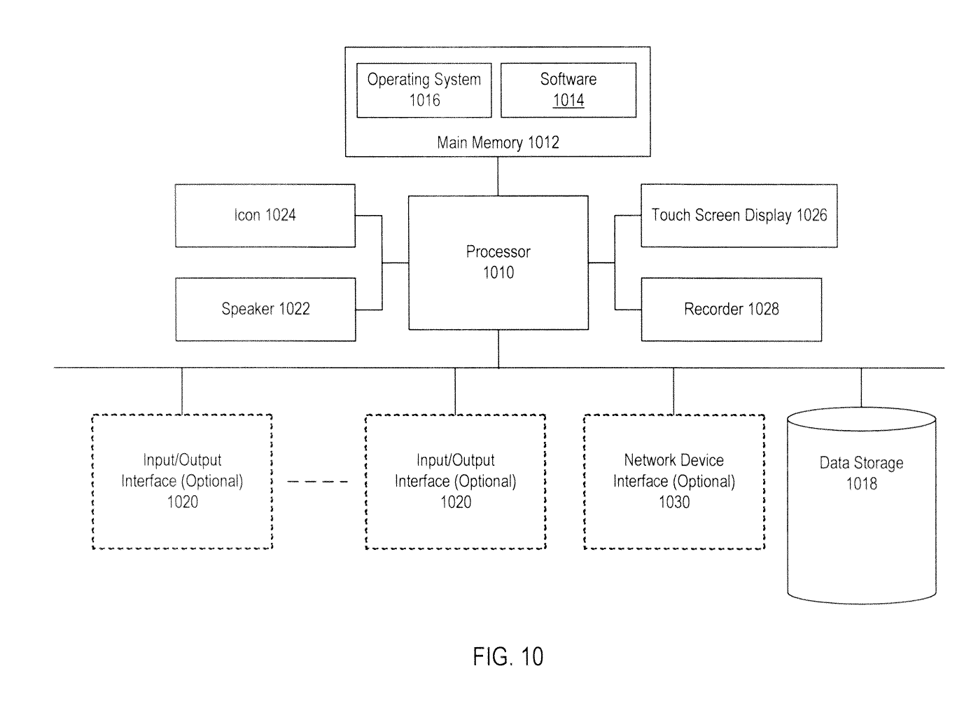

In some embodiments, the system 100 may include an icon or one or more page displays (shown for example in FIGS. 9B and 9D) that lists all of the content available to the user. The device may also include an icon or page display (not shown) that may be used to provide access to features such as touch Screen calibration, screen background light, volume settings, wireless TV out activation or de-activation. The system 100 may also include an icon that may be used to record, listen to and/or delete sound/conversations. The system 100 may also include an active light button 108 (see FIG. 2 for example) that flashes when the unit is active and ready to be used. In certain embodiments, these buttons may be physical buttons. In some embodiments, the buttons may be software buttons included in an application programming interface being displayed on the display of playback device 101. In certain embodiments, the application programming providing the interface for the buttons may be executed on a processor coupled with the display.

FIG. 2, FIG. 3, FIG. 4, FIG. 5 illustrate various views of a display that may be used with certain embodiments disclosed herein.

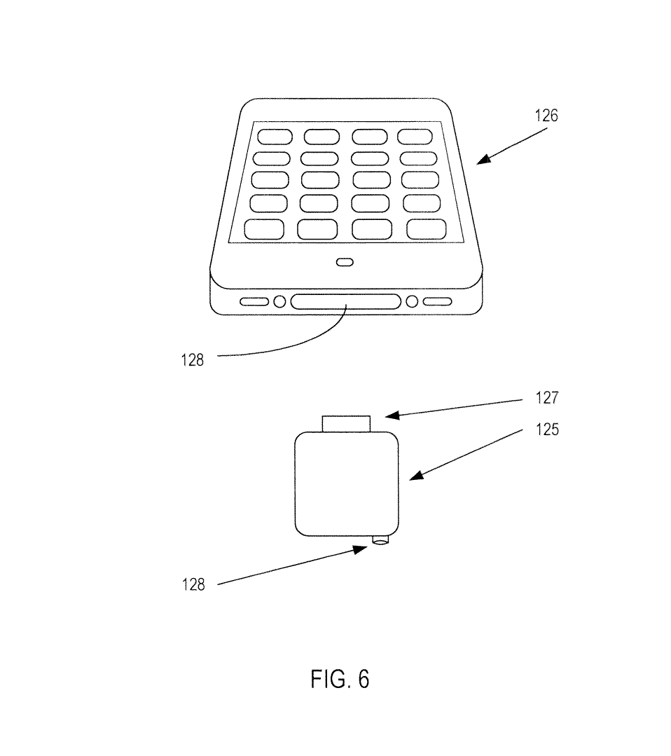

FIG. 6 is an illustration of a view of a reader and a display according to certain embodiments of the present invention. In this embodiment the reader 125 is shown in the form of a plug in device including a male plug 127 adapted to be connected to the data port 128 of a commercially available computerized device, i.e., in the example shown a standard smart phone, such as the iPhone shown, or other type device, such as tablet device, e.g., an iPad. In this arrangement, the reader 125 is configured with a male connector 127 adapted to be inserted into the data port 128. The reader 125 also includes an optical reader head 128 for imaging or scanning steganographic information from printed media. When combined the reader and playback device (the standard iPhone shown in FIG. 6) provides the portable handheld electronic device to be used with special printed material that is provided with the steganographic information and playback supplemental content, as for example audio and/or visual programming.

In some embodiments, the system may operate according to the following procedures:
1. Press the ON/OFF BUTTON
2. Select the desired content either:
   a) by touching the screen
   OR
   b) pressing the FORWARD/BACK buttons (physically coupled with the display or appearing on an application programming interface being displayed on the display), thus toggling between content entries and then press PLAY BUTTON.
3. Content name/image shows up on the screen (e.g., the actual cover of a specially coded book)
4. Communicate with optical reader to activate the reader.
5. Move the reader close to a select page (e.g., coded page) to get started.

Acquire the hidden data in the steganographic information using the reader and transmit back to a processor coupled with the display. Depending on the coded information, content will play (audio, video, still image etc) on the display screen.

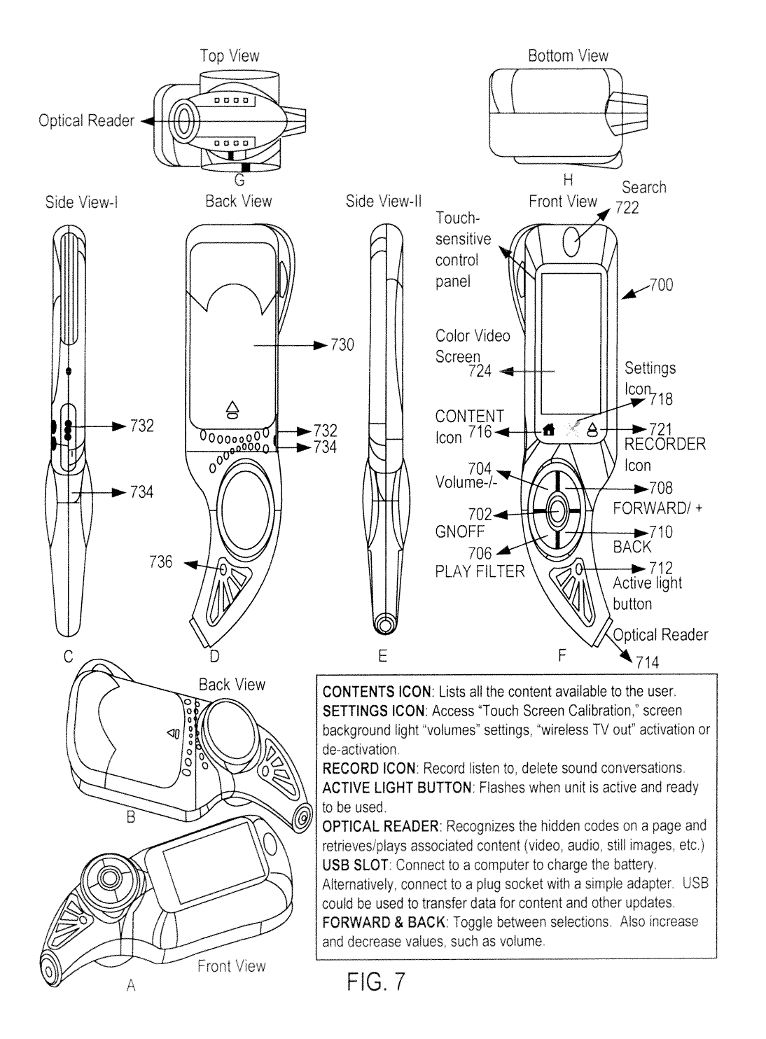

FIG. 7 is another embodiment of a portable hand held electronic system for scanning and/or imaging steganographic information from a printed image. The system of FIG. 7 is an integrated device 700 including a reader and a playback device. In the embodiment shown, FIG. 7F illustrates the front of the integrated device as including on/off control 702, volume control 704, play/enter control 706, forward control 708, back control 710 (the forward and back controls being used to toggle between selections, and to increase and decrease values, such as volume and screen intensity and contrast), an “active” light button 712 (all for controlling playback of preselecting programming. The optical reader 714 is provide for imaging the steganographic data on the accompanying printed material. Three icons 716, 718 and 720 are provided for indicating content, settings and recorder. A speaker is provided at 722 for providing the audio output, and the video screen 724 is provided for displaying video output. Screen 724 can also be used as a touch sensitive control panel. FIG. 7D shows the back of the device 700 as including a battery cover 730 for covering batteries used to power the device, a USB slot 732 and a headphone slot 734 (the slots also shown in FIG. 7C). The USB slot 732 is used to connect the device to a computer to charge the battery. Alternatively, the slot can be used to connect the device to a plug socket with a simple adapter. The slot can also be sued to transfer data for content and other upgrades. An activate button 736 is used to activate the reader when it is positioned over text with the steganographic data.

By way of example, content icon provides a list of all content available to the user, settings icon provides access to such functions as “touch screen calibration”, “screen background light”, “volume settings”, “wireless TV out (providing an output to play on a TV)”, and “activation or deactivation”. In addition, the record icon can, for example, provide record, listen to, delete sound conversations functions. Additional icons can include the “activate” light button that flashes when the unit is active and ready to be used, an optical reader icon which recognizes the hidden codes on a page and retrieves/plays associated content (video, audio, still images, etc.

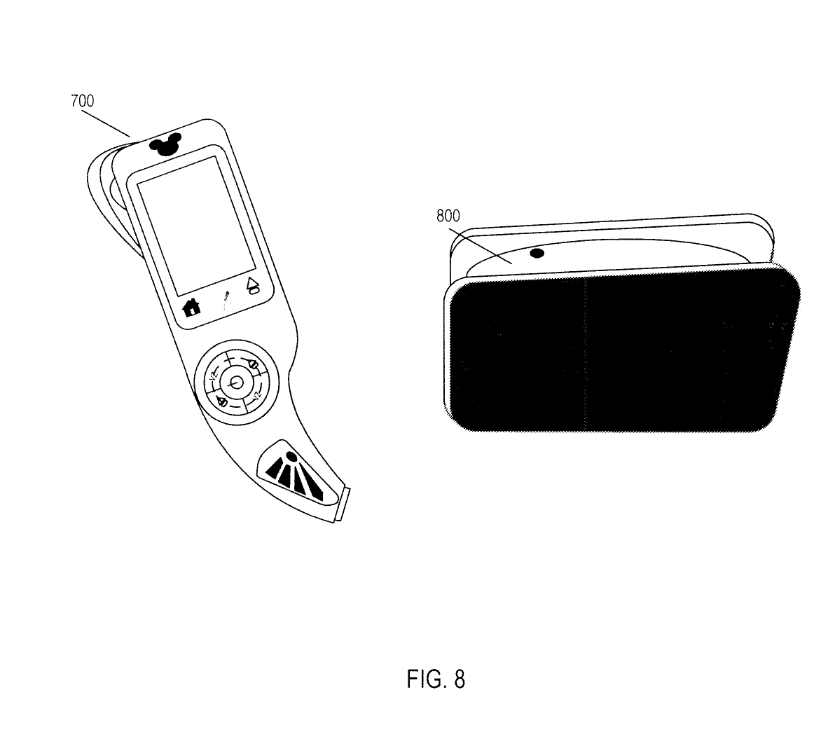

The TV output can be provided to a supplemental system 800 (shown in FIG. 8) for providing duplicate playback, and function to store additional content and functionality.

FIG. 9A-9D shown examples of screen shots of the display of the playback device. FIG. 9A shows a welcome screen, while FIG. 9B shows a list on exemplary programs. A program can be selected for running a displaying the device. A example of a home page of a selected program is shown in FIG. 9C, while an example of content files are shown in FIG. 9D.

FIG. 10 is a high-level block diagram of units that may be coupled with a display screen used with certain embodiments disclosed herein. These units may be included in a data processing device that includes the display (e.g., smart phone) that has the reader connected to it (see FIG. 6), or a reader that is coupled a playback device via a physical or wireless connection such as shown in FIGS. 1-5, or an integrated system such as shown in FIG. 7. A processor 1010 (e.g., Central Processing Unit) may be used to carry out the operations of the device, execute various instructions, and manipulate data structures from the main memory 1012. The CPU processor is coupled to a main memory 1012. The main memory 1012 may be a computer-readable memory and include combinations of non-volatile memory devices. The main memory 1012 may be configured to hold various software programs and program modules 1014 and computer-executable instructions and data structures including computer-executable instructions and data structures that implement aspects of the techniques described herein. For example, the software 1014 may implement the required procedures for identifying information read by the optical reader and playing relevant content.

The main memory 1012 may also include an operating system 1016 that implements various conventional operating system functions including memory management and controlled access to various devices, such as a database storage 1018, and task and process scheduling. The data storage 1018 may include various data for use with embodiments disclosed herein, including images, text, video, audio, and computer applications associated with the steganographic content that is imaged/scanned by the reader.

The CPU processor 1010 may be coupled to various interfaces via an input/output (I/O) device interface 1020. The I/O device interfaces 1020 may include logic to interface with various input and/or output devices, such as a keypad or mouse and with the CPU processor 1010, and allow signals to be transferred between the CPU processor 1010 and other components, such as the optical reader. For example, interface devices such as speaker 1022, icons 1024, touch screen display 1026, recorder 1028 may be used to transfer signals received from a device user (not shown) to the CPU processor 1010 and main memory 1012. In some embodiments, the input/output interface 1020 may include a USB port (not shown). In some embodiments, the device may include a network device interface 1030 that provides the device with access to a network connection.

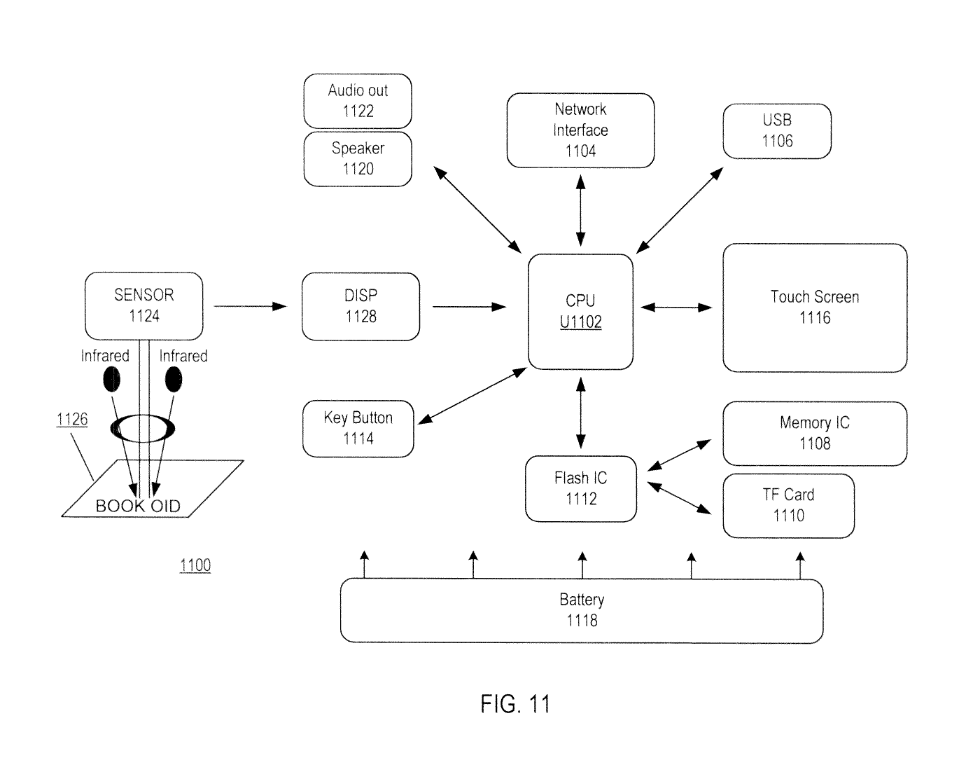

FIG. 11 is a block diagram of an embodiment of a reader disclosed herein. The system 1100 may include a CPU processor 1102. The CPU 1102 may connect to a network connection using a network interface=1104. The network interface 1104 is for a wired or wireless network depending on the application. An input/out put interface (e.g., USB) 1106 may also be included in the system.

The main memory 1108 may be implemented as a computer chip. The main memory 1108 may include elements such as a TransFlash (TF) memory card 1110 and a flash memory interface 1112. One or more Key buttons 1114 may be also be coupled with the CPU 1102 and arranged to forward instructions received from a user (not shown).

The system may also include a touch screen touch screen 1116 that forwards the instructions received from a user (not shown) to the CPU 1102 for processing and execution. The system may also include a battery 1118 that may be used to provide power to the various elements used in the system. The system may also include one or more speakers 1120, an outlet for outputting audio 1122, and/or a microphone (not shown) for receiving audio commands, such as from the user.

A sensor 1024 provided in the reader may be used to obtain (“read”) information included in a printed medium 1026. The sensor 1024 may obtain information regarding the printed content (not shown) without any need for coming in physical contact with the medium including the printed content. The sensor 1024 recognizes the hidden or steganographic (not discernible to the naked eye) codes on the printed medium 1026 and retrieves/plays content (video, audio, still images, etc.) associated with the hidden codes. For example, the word “dog” may appear on a printed page. A hidden code is also printed over, around, or near the word dog. The hidden code may be in various forms such as ORI, Optical Identification (OID), or DPI (dots per inches). The sensor 1125 recognizes the hidden code and forwards information regarding the hidden code via a wireless connection to the CPU 1102. A separate DSP chip 1128, such as a Sonix DSP used to process image data represented by the hidden code and acquired by the sensor so that it can be further processed by the CPU 1102. The CPU and content (video, audio, still images, etc.) related to the word “dog” on the screen 1116. The user can use the key buttons 1114 or the interface provided through touch screen 1116 to select a desired content and work with the selected content.

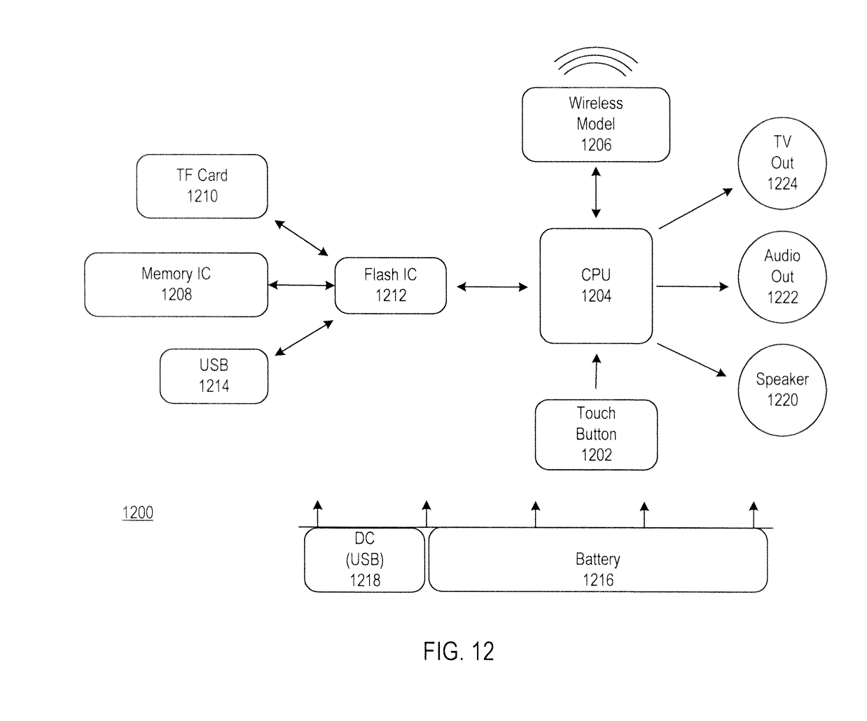

FIG. 12 is a block diagram of an embodiment of a playback device 1200 that includes the display screen described herein or is coupled with the display screen to enable a user to work with various content, such as videos and computer application interfaces. A user may employ one or more touch buttons 1202 to interact with a CPU 1204. The CPU 1204 may connect to a network connection using a wireless/wired network interface 1206. The main memory 1208 may be implemented as a chip and include elements such as a TF memory card 1210 and a flash memory interface 1212. An input/out put interface (e.g., USB) 41214 may also be included.

A battery 1216 may be used to provide power to the various elements used in the device. An interface 1218 for charging the battery through a USB connection may also be employed. The device may also include a speaker 1220, an outlet for outputting audio 1222, and/or an outlet for displaying selected the content 1224.

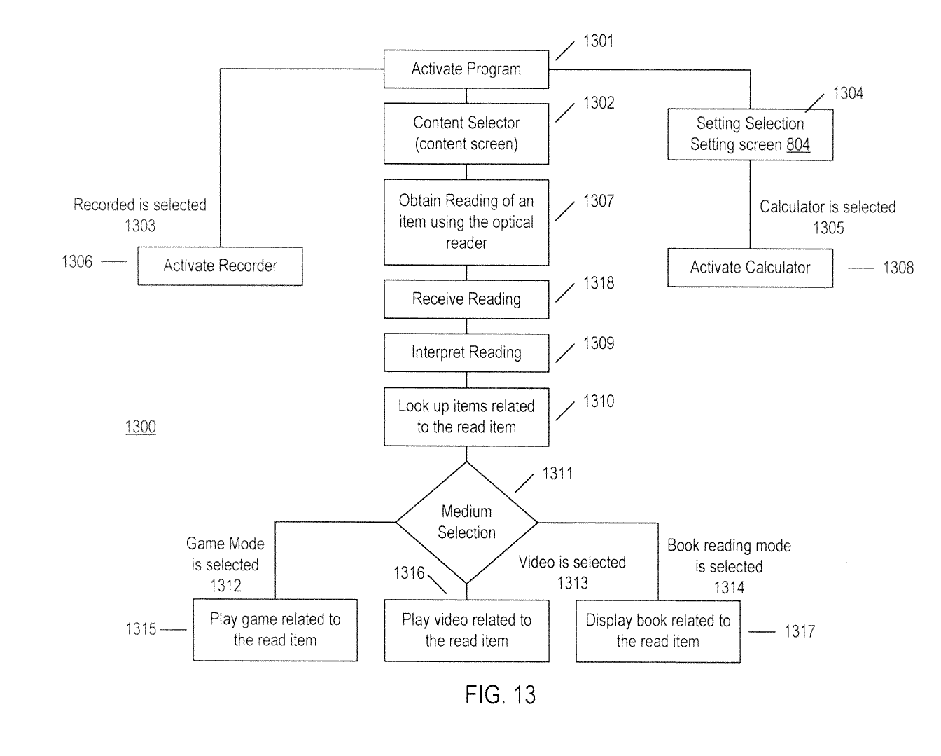

FIG. 13 is a flow diagram of one example 1300 of the process steps of operating the device. Once the system is activated 1301 (e.g., by launching an application program), a user (not shown) may use a content screen of the application programming interface corresponding to the application program to select the content 1302, such as a specially coded book. In one embodiment, the user may proceed from the content screen 1302 to a setting screen that provides the user with various applications, such as a calculator 1305. The user may also proceed directly from the content screen 1302 to a recorder mode 1303. If the calculator mode 1305 is selected, the calculator application program is activated 1308 and a calculator application program interface is displayed on the screen. If the recorder mode is selected 1303, the recorder application program is activated 1306 and a recorder application program interface is displayed on the screen. If the reader mode is selected 1304, the optical reader is activated (optionally by receiving a signal from the computing device hosting the application program) and a reading of a content item is obtained using the optical reader 1307. Signals including information regarding the read content are transmitted back to the application program 1318. The application program interprets the obtained reading 1309, for example using software included in the main memory of the device, and items relating to the read item are identified 1310. The user then is provided with the option of selecting from among available content 1311. For example, the user may select the game mode 1312, the video mode 1316, or the book reading mode 1317. If the game mode is selected 1312, available games (i.e., computer applications) related to the selected content may be presented to the user 1315. The user may then select from among the presented items and work with the selected game. Similarly, if the video mode is selected 1313, various videos related to the selected content may be identified and presented to the user 1316. The user may then select from among the presented videos and watch a selected video. If the book reading mode is selected 1314, a selection of books related to the read content may be displayed 1317. The user may then select a book from among the displayed books and read the selected book or listen to a pre-recorded reading of the selected book.

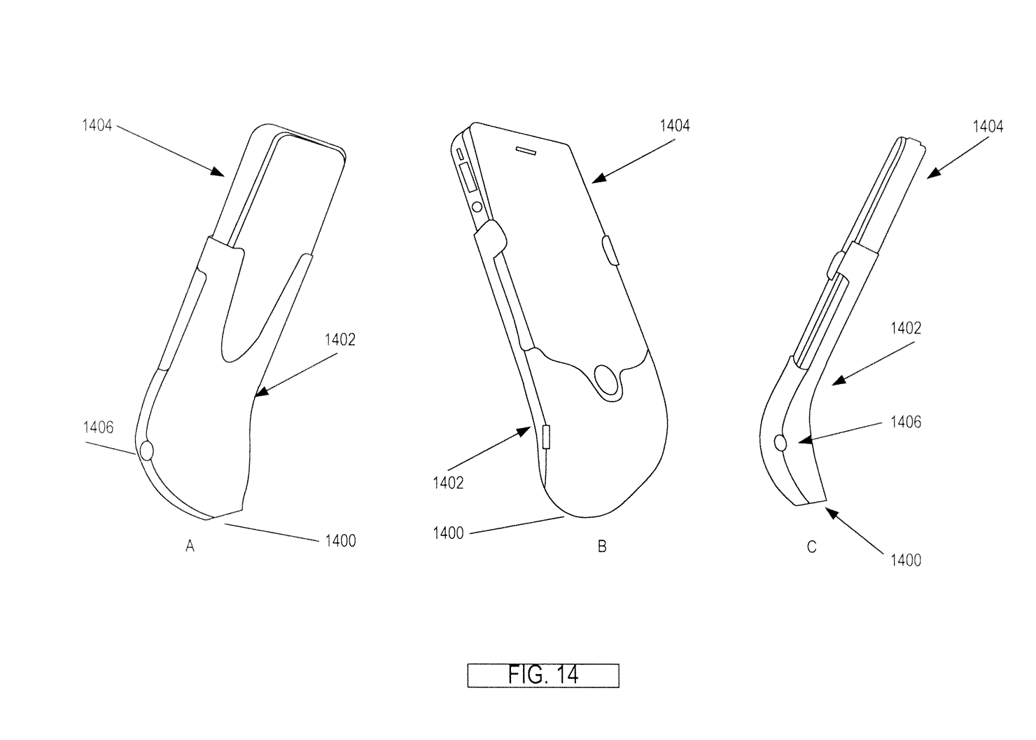

FIG. 14 is an illustration of different views of a reader and a display according to certain additional embodiments of the present invention. As shown an optical reader 1400 and a transmitter (not shown), both reside in a shell casing 1402 shaped like a case for a smart phone device 1404. The optical reader 1400 recognizes the hidden (not discernible to the naked eye) codes representing the steganographic content on a page, transmits that data to the smart phone 1404. The smart phone is configured to include a program that lets the transmitter and the smart phone communicate with each other. The smart phone 1404 responsively retrieves/plays content stored in its memory (video, audio, still images, etc.) associated with the hidden codes on its display/screen.

An example of how the embodiment of FIG. 14 would operate, the user first downloads an app/program from the Internet to his/her phone (shown at 1404. This program will make sure that the smart phone 1404 recognizes the data provided by the reader unit and that the two “talk to each other.” In order to use the device, the user would place the phone inside (sliding the phone into the case. The smart phone is turned on and the downloaded app/program is run. The case tip (optical reader 1400) is then pointed at the specially coded pages, and the control button 1406 is pressed. While pressed, data is transmitted to the phone 1404 and will trigger/run the multimedia content and games on the screen of the phone 1404. In this respect any type of connection can be used to download the multimedia content. For example, either a USB card or SD card can be used. Alternative, the phone 1404 can be connected to the Internet (through for example a Wi-Fi connection) to download the multimedia content to the smart phone 1404. With this setup, contents (movies, audio files, games etc) will not reside in the case where the optical reader is located, but inside the smart phone.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Various modifications may be made to the examples described in the foregoing, and any related teachings may be applied in numerous applications, only some of which have been described herein. It is intended by the following claims to claim any and all applications, modifications and variations that fall within the true scope of the present teachings.

What is claimed is:

1. A system for selectively providing a set of audio and video content associated with a corresponding set of written content separately provided, the system comprising:
a handheld reader including an optical scan reader; and
a playback device, coupled to the reader through a communications link, comprising memory for storing the set of audio and video content associated with corresponding set of written content;
wherein the hand held reader is configured to (a) receive data from the optical scan reader when the optical scan reader scans steganographic coded printed material relating to and in the vicinity of associated written content and (b) transmit the data over the wireless communication link to the playback device; and the playback device is configured to (1) process the data received from the reader over the wireless communications link, (2) retrieve audio and video data associated with the data received from the reader, and (3) display the video data and play the audio data on the playback device.

2. A system according to claim 1, wherein the handheld reader is a stylus including the optical scan reader disposed on one end of the stylus.

3. A system according to claim 1, wherein the playback device is a tablet device.

4. A system according to claim 1, wherein the playback device is a smartphone.

5. A system according to claim 1, wherein the playback device is a smartphone, and the reader is a disposed within a case adapted to fit on and communicate with the smartphone.

6. A system according to claim 1, wherein the wireless communication is in the near infrared.

7. A system according to claim 1, wherein the playback device includes a touchscreen.

8. A system according to claim 1, wherein the audio and video data associated with the data received from the reader is stored in memory as files, each associated with a set of data received from the reader.

9. A system according to claim 1, wherein the reader and playback device are a single integrated unit.

10. A system according to claim 1, wherein the reader and playback device are separate units.

10. A system according to claim 10, wherein the reader and playback device are connected through communication link.

12. A system according to claim 11, wherein the link is wireless.

13. A system according to claim 11, wherein the link is wired.

14. A system according to claim 1, further including reader is configured to sense steganographic data in a non-visible part of the spectrum.

15. A system according to claim 14, wherein the non-visible part of the spectrum is the near infrared.

16. A system for use with a commercially available computerized device and selectively providing a set of audio and video content associated with a corresponding set of written content separately provided, the system comprising:
a handheld reader including an optical scan reader configured to connect to and communicate with the computerized device so that (a) the computerized device functions as a playback device, and (2) when the reader is communicates with the computerized device the combined device is configured to (a) receive data from the optical scan reader when the optical scan reader scans steganographic coded printed material relating to and in the vicinity of associated written content and (b) transmit the data to the computerized device; and the computerized device is configured to (1) process the data received from the reader, (2) retrieve audio and video data associated with the data received from the reader, and (3) display the video data and play the audio data on the playback device.

17. A system according to claim 15, further including printed material encoded with the steganographic coded printed material.

18. A system according to claim 15, wherein the commercially available computerized device is a desktop computer, tablet computer, Personal Digital Assistant (PDA), smart phone and/or mobile device.

19. A system according to claim 18, wherein the handheld reader is disposed within a plug-in device configured to connect to the computerize device.

20. A system according to claim 18, wherein the handheld reader is disposed with a case configured to connect and communicate with the computerized device.
